(19) United States
(12) Patent Application Publication
(10) Pub. No.: US 2026/0225902 A1
(43) Pub. Date: Aug. 6, 2026

(54) SILICALITE-1 CRYSTALS AND PROCESS FOR SYNTHESIS THEREOF

(71) Applicant: ARKEMA FRANCE, Puteaux (FR)

(72) Inventors: Elsy EL HAYEK, LACQ (FR); Cécile LUTZ, LACQ (FR); Ablasis MECHERI, LACQ (FR)

(73) Assignee: ARKEMA FRANCE, Puteaux (FR)

(21) Appl. No.: 19/149,157

(22) PCT Filed: Jan. 23, 2024
(86) PCT No.: PCT/FR2024/050088

§ 371 Date: Jul. 18, 2025

(30) Foreign Application Priority Data
Jan. 27, 2023 (FR) FR2300783

(51) Int. Cl. C01B 39/48

(52) U.S. Cl. CPC C01B 39/48; C01P 2004/03; C01P 2004/54; C01P 2004/61

(57) ABSTRACT

The present invention relates to MFI-type silicalite-1 zeolite crystals that are individual crystals having a three-dimensional morphology in which the cross section parallel to the longest length corresponds in shape to a straight-line-truncated disk (or ellipse). The invention also relates to the process for synthesizing said crystals and to the use thereof as zeolitic adsorbents.

### CROSS-REFERENCE TO RELATED APPLICATIONS

This application is the U.S. National Phase of PCT International Application No. PCT/FR2024/050088, filed Jan. 23, 2024, which claims priority to French Patent Application No. FR 2300783, filed Jan. 27, 2023, the contents of these applications being incorporated by reference herein in their entireties for all purposes.

### FIELD OF THE INVENTION

The present invention relates to the field of zeolites, more precisely to the field of MFI-type zeolites and in particular to that of silicalite-1. The present invention concerns in particular the synthesis of silicalite-1 zeolite and also the process for synthesizing small crystals of silicalite-1.

### BACKGROUND OF THE INVENTION

The term “zeolites” generally encompasses crystalline microporous aluminosilicates benefiting from various crystalline structures in which the proportion of silicon and aluminum, often referred to as the Si/Al atomic ratio, is highly variable. In particular, crystalline MFI-type zeolites are termed “ZSM-5” if aluminum is present in their framework or termed “silicalite-1” when the framework is purely silicic. The absence of aluminum in their network means that the latter benefit from better thermal stability, enhanced hydrophobicity and enhanced organophilicity. Silicalite-1 zeolites are accordingly employed in industry for a diversity of uses such as adsorption, catalysis, and separation.

The currently known synthetic routes for silicalite-1 zeolites frequently employ synthesis gels containing mineralizers, for example fluorinated mineralizers, and also organic structuring agents, which are often used in large or even very large amounts.

These currently known synthetic routes are in addition generally characterized by relatively long durations, for example from a few tens of hours to several days, or even about ten days. In addition, these syntheses can necessitate high crystallization temperatures, which means that operations most often need to be carried out under pressure, which can be something of a hindrance as well as involving additional outlay on industrial plants.

Moreover, the syntheses of silicalite-1 zeolites known from the prior art often result in crystals of relatively large sizes, for example of the order of a few tens of micrometers.

Other syntheses of silicalite-1 involve the use of various reagents posing a certain operational challenge. Thus, syntheses of silicalite-1 with a fluorinated mineralizer are described for example in document CN105858672B. The use of fluorinating agent complicates the synthesis operation because of the hazardousness of the fluorinated species potentially formed (for example hydrofluoric acid). On the other hand, document CN112607746A presents a means of synthesizing silicalite-1 crystals having hierarchical porosity, wherein, in addition to the structuring agent, an additional compound derived from guanidine must be employed to create a certain degree of mesoporosity.

Also described in the literature are other syntheses of zeotypes, which are zeolites that have similar crystalline structures but contain, incorporated in the framework in addition to silicon, one or more other elements, including titanium and boron as non-limiting examples. Thus, patent applications U.S. Pat. No. 10,766,871 AA and US20220266236 A1 describe syntheses of silicalite zeotypes containing titanium and boron, which are not the aim here, given the complexity and cost of such syntheses and such end structures.

The article Catalysts, 2019, 9, 13, doi:10.3390/catal9010013 by Jianguang Zhang et al. provides syntheses of silicalite-1 from different sources of silica at high temperature (453 K, or about 180° C.) involving large amounts of organic structuring agent of the order of 30%. But none leads to individual crystals, that is to say crystals with no twinning and having regular and homogeneous morphologies.

Patent CN112850740 provides a synthesis that results in the formation of needle-shaped crystals that have irregular dimensions and are therefore difficult to utilize in the fields of use in which silicalite-1 is commonly employed.

### SUMMARY OF THE INVENTION

One of the objects of the present invention is to provide individual crystals of silicalite-1 having a very particular and regular morphology and in particular a morphology referred to as a “straight-line-truncated disk (or ellipse)” having a certain thickness. A morphology of this kind may be referred to as a “squircle”, a term combining the words “square” and “circle” in order to describe three-dimensional shapes that in cross section parallel to the largest dimension of the crystal are a disk (or ellipse) truncated by at least straight lines parallel to one another. Examples of such morphologies are for example those illustrated in FIG. 1 appended to the present description.

Another object of the present invention is to provide individual crystals of silicalite-1 having a relatively small number-average diameter, measured by scanning electron microscopy, for example between 0.2 μm and 7 μm, and a narrow monomodal particle size distribution, also determined by SEM counting, typically with a peak width (2σ) of less than 5.

Yet other objects will emerge in the light of the description that follows. In the present invention, and unless otherwise indicated, all ranges of values introduced by the expressions “from . . . to . . . ” or “between . . . and . . . ” , or other similar expressions intended to encompass two values, are understood to be with limits included, unless expressly indicated otherwise.

According to a first aspect, the present invention relates to MFI-type silicalite-1 zeolite crystals:
in which the number-average diameter measured by scanning electron microscopy is between 0.2 μm and 7 μm,
in which the width/length ratio measured by examination with a scanning electron microscope is between 0.1 and 1 and the thickness/length ratio measured by examination with a scanning electron microscope is between 0.05 and 0.5, and
in which the monomodal particle size distribution determined by examination with a scanning electron microscope has a peak width 2σ of equal to or less than 5.

### BRIEF DESCRIPTION OF THE DRAWINGS

FIGS. 1a, 1b, 1c, and 1d show diagrams illustrating examples of crystal shapes according to the invention in which the cross sections parallel to the largest dimension are “squircles”.

FIG. 2 shows an X-ray diffraction pattern of the silicalite-1 crystals from example 1.

FIG. 3 (divided into FIGS. 3a and 3b) shows SEM images of the silicalite-1 crystals from example 1.

FIG. 4 shows the X-ray diffraction pattern of the MFI-type silicalite-1 zeolite crystals from example 2.

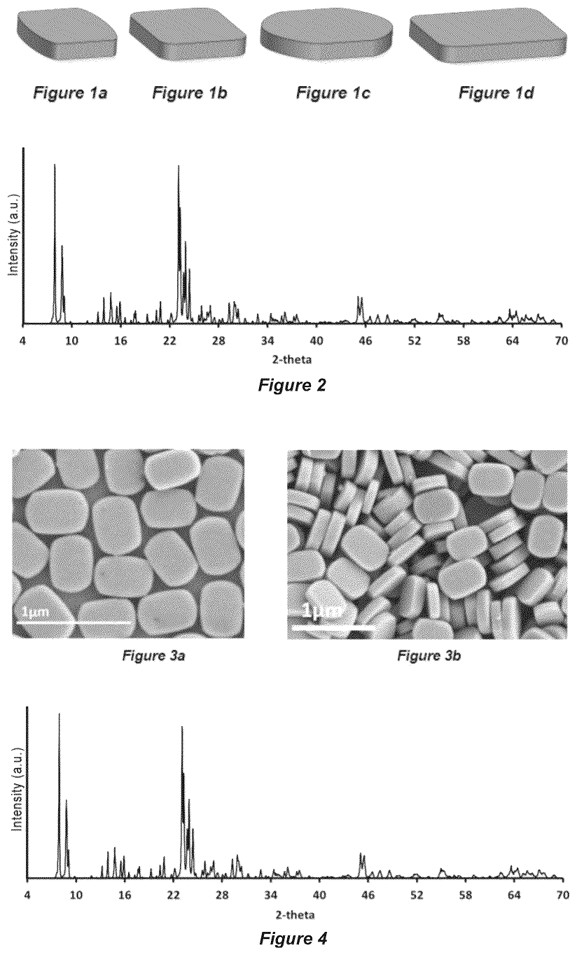

### DETAILED DESCRIPTION OF THE INVENTION

According to a preferred embodiment, the number-average diameter measured by scanning electron microscopy is between 0.2 μm and 6 μm, better still between 0.3 μm and 6.0 μm, advantageously between 0.3 μm and 5.0 μm, and most preferably between 0.3 μm and 4.0 μm.

According to another preferred embodiment of the present invention, the crystals have a width/length ratio of between 0.15 and 0.90, more preferably between 0.2 and 0.85. According to another embodiment, the thickness/length ratio of the crystals according to the present invention is preferably between 0.1 and 0.4. Unless otherwise indicated, all crystal sizes are measured by examination with a scanning electron microscope (SEM), as outlined hereinbelow in the paragraphs relating to analytical techniques.

According to yet another preferred embodiment, the particle size distribution of the average diameter is a monomodal particle size distribution having a peak width 2σ of equal to or less than 4, advantageously equal to or less than 3, better still equal to or less than 2, and most preferably equal to or less than 1.

“Monomodal” distribution is understood as meaning a distribution that is not significantly different from the log-normal distribution at a risk of 1%, the log-normal distribution applied to the statistical results from the x² (chi-squared) test (using the “Statistica” software from StatSoft France). More specifically, “distribution not significantly different from the log-normal distribution at a risk of 1%” is understood as meaning that the risk “p” of the x² test is greater than or equal to 1%, preferably greater than or equal to 5%, more preferably greater than or equal to 8%.

The MFI-type silicalite-1 zeolite crystals of the invention have a very particular three-dimensional morphology in which the cross section parallel to the longest length corresponds in shape to a straight-line-truncated disk or ellipse, as defined above.

In addition, the MFI-type silicalite-1 zeolite crystals of the invention show high regularity of shape and size and, more precisely, none of the dimensional characteristics (length, width, and thickness) of the crystals of the invention show variations of greater than 15%, preferably greater than 10%, by examination with a scanning electron microscope.

In yet another preferred aspect of the present invention, the silicalite-1 crystals are pure, this purity being verified by the absence of parasitic phases identified and identifiable by X-ray diffraction (XRD).

Thus, the crystals obtained according to the process of the present invention are characterized generally and most often by a Dubinin volume equal to or greater than 0.10 cm³·g⁻¹, preferably equal to or greater than 0.14 cm³·g⁻¹, more preferably equal to or greater than 0.16 cm³·g⁻¹.

According to another aspect, the present invention relates to the process for synthesizing the MFI-type silicalite-1 zeolite crystals as they have just been defined. The synthesis process of the invention comprises at least the following steps a) to d):
a) feeding a batch reactor or tubular reactor with a synthesis medium comprising a source of silicon, an organic structuring agent and seeds;
b) raising the temperature of the synthesis medium to between 70° C. and 170° C.;
c) crystallizing at a temperature at least equal to the temperature in the preceding step, at a temperature in the range from 70° C. to 170° C.;
d) collecting the silicalite-1 zeolite crystals, as defined above.

The synthesis medium is prepared by mixing a source of silicon, a structuring agent and seeds, it being possible for said mixing to be carried out by any method well known to those skilled in the art and using any type of apparatus likewise well known to those skilled in the art.

A source of silicon is understood as meaning any source well known to those skilled in the art and in particular a solution, preferably aqueous, of a silicate, in particular of a silicate or orthosilicate of an alkali metal or alkaline earth metal, for example of sodium, or of colloidal silica or alternatively of tetraethyl orthosilicate, to mention just the principal sources of silicon that are the most common and most widely used for the preparation of zeolite crystals.

A structuring agent is understood as meaning any organic source well known to those skilled in the art that makes it possible to obtain an MFI-type structure, in particular a solution containing amines, preferably aqueous, such as a tetrapropylammonium halide, preferably bromide, tetrapropylammonium hydroxide, tetrabutylammonium hydroxide, and the like, to mention just the most well-known and widely used structuring agents.

According to a preferred embodiment of the invention, the synthesis medium comprises:
a source of silicon that is an aqueous solution of a silicate or orthosilicate of an alkali metal or alkaline earth metal, for example and preferably sodium, or colloidal silica,
an organic structuring agent that is an aqueous solution of tetrapropylammonium bromide, tetrapropylammonium hydroxide, tetrabutylammonium hydroxide, in particular tetrapropylammonium hydroxide or tetrabutylammonium hydroxide, and
seeds.

Optionally, the synthesis medium may also comprise a source of sodium, for example in the form of sodium hydroxide.

In the context and synthesis process of the present invention, seeds are understood as meaning any seeds well known to those skilled in the art and in particular those selected from:
nucleating solutions, that is to say suspensions of nuclei obtained from a source of silicon, an organic structuring agent and optionally water and sodium hydroxide,
crystals of MFI-type zeolites, and most particularly of MFI-type ZSM-5 zeolites or MFI-type silicalite-1 zeolites, or of MEL type; said zeolite crystals may optionally be ground or cryoground beforehand, preferably to a submicron size.

According to a most preferred aspect of the process of the present invention, the seeds are introduced either as a mixture with the source of silicon and/or the structuring agent, or again after the introduction of the source of silicon and the structuring agent into the synthesis reactor. The seeds may be introduced by any procedure well known to those skilled in the art, and most preferably upstream of the crystallization step.

The percentage by weight of the seeds relative to the total weight of the synthesis medium is generally and most often between 0.1% and 20%, preferably between 0.1% and 10%, more preferably between 0.1% and 5%.

The H₂O/SiO₂ molar ratio in the synthesis medium before introduction of the seeds is generally between 1 and 100, preferably between 5 and 90, and most preferably between 5 and 70. The Na₂O/SiO₂ molar ratio is between 0 and 0.5, preferably between 0 and 0.3, more preferably between 0 and 0.2, inclusive.

The R/SiO₂ molar ratio is between 0 and 0.5, preferably between 0 and 0.3, more preferably between 0 and 0.2, limits excluded, where R represents the organic structuring agent. The process of the present invention is thus characterized by the mandatory presence in the synthesis medium of at least one structuring agent, even if present only in a very small amount.

According to yet another preferred embodiment, the synthesis medium, before introduction of the seeds, has:
an H₂ O/SiO₂ molar ratio of between 1 and 100, preferably between 5 and 90, and more preferably between 5 and 70,
an Na₂O/SiO₂ molar ratio of between 0 and 0.5, preferably between 0 and 0.3, and more preferably between 0 and 0.2, and
an R/SiO₂ molar ratio of between 0 and 0.5, preferably between 0 and 0.3, more preferably between 0 and 0.2, limits excluded, where R represents the organic structuring agent.

The process of the present invention for synthesizing MFI-type silicalite-1 zeolite crystals can be executed in any type of reactor commonly used for the synthesis of zeolite crystals and well known to those skilled in the art. In particular, the reactor may be a batch reactor fed discontinuously or even a tubular reactor fed continuously, in the latter case optionally preferably provided with one or more stirring systems selected from mechanical stirring and oscillation stirring systems, and also combinations of one or more mechanical stirring systems with one or more oscillation stirring systems.

In the process of the present invention, preference is given to using reactors that allow batch-type or continuous-type syntheses, have one type of stirring system, and have preferably just one type of stirring system, either mechanical or oscillatory.

The abovementioned stirring means may be of any type well known to those skilled in the art; for example and in a non-limiting manner, when the reactor is a batch reactor it may be of the bladed impeller, deflocculator, turbine-type shearing impeller, Archimedes' screw or anchor type, and when the reactor is a tubular reactor it is possible to simulate suitable stirring systems through the presence in said tubular reactor of restrictions such as rings, baffles, and the like. As a variant, or in addition, said reactor may be equipped with one or more stirring systems, for example a stirring shaft provided with a plurality of stirring impellers, a cascade of stirrers distributed along the reactor, and/or one or more oscillating or pulsing systems that generate a reciprocating movement in the reaction medium by means of, for example, a piston, a diaphragm, head-to-tail pumps, and the like, or else two or more of these techniques combined.

The reactor used for the process of the present invention further comprises at least one heating system for all or part of the reactor and also optionally a heat insulation system for all or part of the reactor. The reactor may also comprise one or more ultrasound sources in order to promote the crystallization and/or formation of mostly individual crystals, that is to say with few aggregates or none at all.

Said at least one heating system may be of any type well known to those skilled in the art and for example selected from steam injection systems, jacketed systems containing a heat-transfer fluid, systems employing an additional microwave source, and systems combining one or more of the aforementioned means.

The heating system must permit a rise in temperature during step b) and subsequent rise to the crystallization temperature and also the maintenance of the temperature during step c). The crystallization temperature in step c) is most often and advantageously equal to or greater than the temperature attained in step b).

The temperature rise in step b) is carried out up to a temperature of between 70° C. and 170° C. Typically, but not exclusively, the duration of the temperature rise is between 0.1 hours and 10 hours. It would not constitute a departure from the scope of the invention if the temperature attained at the end of the rise was maintained for a period of between 0.1 hours and 20 hours.

According to the present invention, the crystallization step (step c)) is carried out at a temperature in the range from 70° C. to 170° C., more preferably from 70° C. to 160° C., and most preferably from 70° C. to 150° C., for example from 70° C. to 130° C.

The duration of the crystallization step can vary widely and is generally between a few minutes and several hours, most often for a period varying from 30 minutes to 72 hours, preferably from 30 minutes to 48 hours, more preferably from 1 hour to 30 hours.

During the temperature rise (step b)) and crystallization (step c)) steps, the pressure is between atmospheric pressure and 1.5 MPa. Preferably, the pressure is equal to the autogenous pressure.

The silicalite-1 crystals are collected by any means known to those skilled in the art, for example by any means or combination of means selected from continuous filtration, discontinuous filtration, centrifugation, and lyophilization. The crystals are then generally and most often washed by any suitable means, for example by means of an aqueous solution. The crystals are then optionally calcined by conventional techniques known to those skilled in the art, for example, and without limitation, at 550° C. for 6 h.

The synthesis process of the present invention brings numerous advantages, including, in particular, the production of crystals of reduced size, the reduction in energy costs and raw materials costs, and also increased production quality and an improvement in the regularity of production.

Moreover, the process of the present invention permits synthesis in a non-fluorinated medium, employing only small amounts of organic structuring agent, potentially at relatively low crystallization temperatures. The present invention thus provides a synthesis process that is easy to industrialize, economical, and efficient.

As indicated above, the process according to the present invention makes it possible to obtain, in a wholly simple and efficient manner, MFI-type silicalite-1 zeolite crystals having a homogeneous particle size and morphology.

In addition, the process of the present invention makes it possible to obtain well-crystallized crystals of impurity-free MFI-type silicalite-1 zeolite characterized by small crystals having a regular morphology, preferably a “straight-line-truncated disk (or ellipse)” morphology, in which the number-average diameter of the crystals is between 0.2 μm and 7 μm, and having a monomodal particle size distribution.

By virtue of the particular properties of the zeolite crystals of the present invention, in particular their homogeneity in size and their regular morphology of the “straight-line-truncated disk (or ellipse)” type, the incorporation of said crystals in various organic polymer matrices is greatly facilitated by comparison with crystals having a broader particle size distribution and/or less regular morphologies.

Another advantage in particular is that the use of a fluorinating agent is dispensed with. In addition to the advantage of simplification of execution, the absence of fluorinating agent significantly reduces the impact on the environment, these agents being very often corrosive. In addition, the fluorinating agent-free process simplifies the effluent treatment step, thus reducing the production costs of the zeolite.

The particular morphology of the crystals of the present invention permits the use and easy dispersion thereof in all types of matrices, whether they be liquid, pasty or pulverulent solids, by comparison with the morphologies typically obtained in the prior art (spheres, hexagons, needles), whether this be for uses in adsorption, separation or catalysis.

The homogeneous size of the crystals (monomodal distribution) and their small average diameter permit, for example, good crystal flowability and optimal control of the diffusion properties in the many uses, and further promote dispersion in all types of matrices.

The crystals of the invention can also, and advantageously, be pelletized by any conventional techniques well known to those skilled in the art, for example using a pelletization binder, for example a clay-or alumina-type binder. As a consequence in particular of their shape, homogeneity, and mostly individual nature, the crystals of the invention show little mesoporosity, or even no mesoporosity at all. In addition, when the crystals of the invention are pelletized and shaped, they lead to the formation of a particularly regular porous network within the pellet.

Thus, the crystals of the invention, in powder form, optionally but preferably activated, or else in the form of shaped pellets, have some very interesting uses as zeolitic adsorbents in numerous fields, including the fields of recycling, packaging, electric batteries, coatings (such as paints and varnishes), water treatment, electronics, the medical, food and chemical industries in general, fields utilizing the adsorption properties of zeolites, for example adsorption of organic compounds and of volatile organic compounds in particular, in aqueous and/or organic media, adsorption of odors, separation of chemical compounds in liquid or gaseous media, or as a support for catalytic metals and the like, to name just the principal fields of use.

### Analytical Techniques

### Estimation of Crystal Size

The size of the zeolite crystals is estimated by examination with a scanning electron microscope (SEM). In order to estimate the size of the zeolite crystals in the samples, a set of images is acquired at a magnification of at least 5000. The diameter of a straight-line-truncated disk is defined as the diameter of the circumscribed circle.

The length (which is equivalent to the diameter of the circumscribed circle), and also the width and thickness, of at least 200 crystals are then measured using dedicated software, for example the Smile View software from the publisher LoGraMi. The number-average diameter is obtained by calculating the number-average of the crystal lengths. The accuracy is of the order of 3%.

### Qualitative Analysis by X-Ray Diffraction

The purity of the zeolites in the zeolitic adsorbent materials is evaluated by X-ray diffraction analysis, known to those skilled in the art by the acronym XRD. This identification is carried out on a Bruker XRD instrument.

This analysis makes it possible to identify the various zeolites present in the adsorbent material, since each zeolite structure has a unique diffraction pattern defined by the positions of the diffraction peaks and by their relative intensities.

Before measurement, the zeolitic materials are ground and then spread out and smoothed on a sample holder by simple mechanical compression.

The conditions under which the diffraction pattern is acquired on the Bruker D5000 instrument are as follows:
Cu tube used at 40 kV-30 mA;
slit size (divergent, scattering and analysis slits)=0.6 mm;
filter: Ni;
sample device rotating at: 15 rpm;
measuring range: 3°<2θ<50°;
step: 0.02°;
counting time per step: 2 seconds.

The diffraction pattern obtained is interpreted using the EVA software with identification of the zeolites with the aid of the ICDD PDF-2 database, 2011 release.

### Microcrystallinity by Dubinin Volume

The Dubinin volume (or micropore volume Vₘ) is determined in a conventional manner well known to those skilled in the art, in particular from measurement of the adsorption isotherm of a gas at its liquefaction temperature, for example nitrogen, argon, oxygen, and the like. Preference is given to using nitrogen. Before said adsorption measurement, the zeolite crystals of the invention are degassed under reduced pressure (pressure<6.7⁻⁴ Pa) at between 300° C. and 450° C. for a period in the range from 9 hours to 16 hours. For example, for an MFI-type zeolite such as silicalite-1, the nitrogen adsorption isotherm at 77K is then measured on a Micromeritics ASAP 2020 instrument, taking at least 35 measurement points at relative pressures having a P/P₀ ratio of between 0.002 and 1. The micropore volume is determined according to the Dubinin-Raduskevitch equation from the resulting isotherm, employing standard ISO 15901-3:2007. The micropore volume thus evaluated is expressed in cm³ of liquid adsorbent per gram of anhydrous adsorbent. The measurement uncertainty is ±0.003 cm³·g⁻¹.

### Example 1 (According to the Invention)

For the batch synthesis of silicalite-1 zeolite, a solution of tetraethyl orthosilicate (Sigma-Aldrich, CAS 78-10-4), a solution of tetrapropylammonium hydroxide (Thermo-Fisher, CAS 4499-86-9), and seeds are introduced into a batch reactor, as indicated below.

A tetrapropylammonium hydroxide solution of composition 0.03 TPAOH (tetrapropylammonium hydroxide), 13.22H₂ O is prepared. A silicate solution of composition 1 SiO₂ 7.78H₂O is prepared. The seeds consist of crystals of ZSM-5 (Alfa Aesar, CAS 1318-02-1) in a proportion of 0.27% by weight relative to the weight of the synthesis medium.

The synthesis medium is prepared by mixing in the batch reactor the tetrapropylammonium hydroxide solution, the tetraethyl orthosilicate solution, and then the seeds. The reactor is then heated to 98° C. by a jacket. The residence time in the reactor is 26 hours.

At the end of this synthesis, a pure silicalite-1 zeolite, that is to say having a diffraction pattern strictly characteristic of an MFI-type zeolite, is obtained (see X-ray diffraction pattern, FIG. 2), and has a Dubinin volume of 0.170 cm³·g⁻¹. The crystals obtained are homogeneous in size, mostly individual (no twinning), and have a number-average size (length) by examination with a scanning electron microscope (SEM) (see paragraph “Analytical techniques”) of 0.5 μm and a truncated ellipse morphology (see FIGS. 3a and 3b), and have an average crystal thickness/length ratio of 0.3 and an average crystal width/length ratio of 0.7. The 2σ value is equal to 0.16 μm.

### Example 2 (According to the Invention)

For the batch synthesis of silicalite-1 zeolite, a suspension of colloidal silica (Sigma Aldrich, CAS 7631-86-9), a solution of TPAOH (Thermo-Fisher, CAS 4499-86-9), and seeds, as detailed below, are introduced into a batch reactor. A tetrapropylammonium hydroxide solution of composition 0.03 TPAOH 13.22H₂O is prepared. A silicate solution of composition 1 SiO₂ 7.78H₂O is prepared. The seeds consist of crystals of ZSM-5 (Alfa Aesar, CAS 1318-02-1) in a proportion of 0.27% by weight relative to the weight of the synthesis medium.

The synthesis medium is prepared by mixing in the batch reactor the tetrapropylammonium hydroxide solution, the suspension of colloidal silica and then the seeds. The reactor is then heated to 98° C. by a jacket. The residence time in the reactor is 26 hours.

At the end of this synthesis, a pure MFI-type silicalite-1 zeolite, that is to say having a diffraction pattern strictly characteristic of an MFI-type zeolite, is obtained (see X-ray diffraction pattern, FIG. 4), and has a Dubinin volume of 0.172 cm³·g¹. The crystals obtained are mostly individual (no twinning), and have a number-average size (length) of 0.52 μm and a truncated ellipse morphology. The average crystal thickness/length ratio is 0.26 and the average crystal width/length ratio is 0.64. The 2σ value is equal to 0.18 μm.

### Example 3 (Comparative)

Example 1 of patent CN112850740 was reproduced. As indicated in this patent, MFI-type silicalite-1 zeolite crystals having a lamellar morphology (FIG. 2 of patent CN112850740) are obtained, that is to say crystals of morphology quite different from that of the present invention. The silicalite-1 crystals obtained have needle morphologies of different dimensions. The needles of very variable dimensions have on average the following approximate sizes: 20 nm×200 nm×2000 nm and therefore an average crystal size (length) of 2 μm, a calculated average thickness/length ratio of 0.01 and a calculated average width/length ratio of 0.1. The crystals have a very different morphology compared to the morphology of the crystals of the present invention and show great heterogeneity.

1. MFI-type silicalite-1 zeolite crystals:
in which the number-average diameter measured by scanning electron microscopy is between 0.2 μm and 7 μm,
in which the width/length ratio measured by examination with a scanning electron microscope is between 0.1 and 1 and the thickness/length ratio measured by examination with a scanning electron microscope is between 0.05 and 0.5, and
in which the monomodal particle size distribution determined by examination with a scanning electron microscope has a peak width 2σ of equal to or less than 5.

2. The crystals as claimed in claim 1, where the number-average diameter measured by scanning electron microscopy is between 0.2 μm and 6 μm.

3. The crystals as claimed in claim 1, where the width/length ratio is between 0.15 and 0.90, measured by examination with a scanning electron microscope.

4. The crystals as claimed in claim 1, where the thickness/length ratio is between 0.1 and 0.4, measured by examination with a scanning electron microscope.

5. The crystals as claimed in claim 1, where the peak width 2σ of the monomodal particle size distribution of the number-average diameter is equal to or less than 4.

6. The crystals as claimed in claim 1, having a very particular three-dimensional morphology in which the cross section parallel to the longest length corresponds in shape to a straight-line-truncated disk or ellipse.

7. The crystals as claimed in claim 1, where none of the dimensional characteristics (length, width, and thickness) show variations of greater than 15%, by examination with a scanning electron microscope.

8. A process for synthesizing the crystals defined in claim 1, comprising at least the following steps a) to d):
a) feeding a batch reactor or tubular reactor with a synthesis medium comprising a source of silicon, an organic structuring agent and seeds;
b) raising the temperature of the synthesis medium to between 70° C. and 170° C.;
c) crystallizing at a temperature at least equal to the temperature in the preceding step, at a temperature in the range from 70° C. to 170° C.;
d) collecting the silicalite-1 zeolite crystals, as defined above.

9. The process as claimed in claim 8, wherein the synthesis medium comprises:
a source of silicon that is an aqueous solution of a silicate or orthosilicate of an alkali metal or alkaline earth metal, or colloidal silica,
an organic structuring agent that is an aqueous solution of tetrapropylammonium bromide, tetrapropylammonium hydroxide, tetrabutylammonium hydroxide, and
seeds.

10. The process as claimed in claim 8, wherein the synthesis medium additionally comprises a source of sodium.

11. The process as claimed in any claim 8, wherein the percentage by weight of the seeds relative to the total weight of the synthesis medium is between 0.1% and 20%.

12. The process as claimed in claim 8, wherein the R/SiO₂ molar ratio is between 0 and 0.5, limits excluded, where R represents the organic structuring agent.

13. The use of the crystals defined in claim 1, in powder form, optionally activated, or else in the form of shaped pellets, as zeolitic adsorbents in the fields of recycling, packaging, electric batteries, coatings (such as paints and varnishes), water treatment, electronics, and in the medical, food and chemical industries in general.

14. The use as claimed in claim 13 for the adsorption of organic compounds, the adsorption of volatile organic compounds, in aqueous and/or organic media, adsorption of odors, separation of chemical compounds in liquid or gaseous media, or as a support for catalytic metals.
